(19) United States
(12) Patent Application Publication
(10) Pub. No.: US 2005/0060875 A1
(43) Pub. Date: Mar. 24, 2005

(54) Device for the manufacture of a shaft assembly for a hydrodynamic bearing

(75) Inventors: Carsten Etling, Spaichingen (DE); Eduard Hudec, Villingen-Schwenningen (DE)

Correspondence Address: Lipsitz & McAllister, LLC, 755 MAIN STREET, MONROE, CT, 06468, US

(73) Assignee: Minebea Co., Ltd., Magano-ken (JP)

(21) Appl. No.: 10/920,032

(22) Filed: Aug. 16, 2004

(30) Foreign Application Priority Data
Aug. 19, 2003 (DE) 103 38 139.2

(51) Int. Cl. F16C 32/06; B23P 19/04

(52) U.S. Cl. 29/724; 29/898.02

(57) ABSTRACT

In order to create a device for the manufacture of a shaft assembly for a hydrodynamic bearing by pressing the shaft into a fit bore in the bearing disk, the device comprising a first pressing tool accommodating the shaft and a second pressing tool accommodating the bearing disk, in which the said disadvantages can be remedied to a great extent so that particularly one-sided “touching” and the resulting “seizing” hardly ever take place, leading to a considerable reduction in the percentage of rejected parts, it is proposed that the second pressing tool has a supporting member carried by the base member and accommodating the bearing disk that is to be pressed and that the supporting member is supported with respect to the base member in a radial direction to a central axis of the pressing tools by means of a media cushion formed from a medium, the supporting member floating on this media cushion and its movement in this radial direction being restricted.

The present disclosure relates to the subject matter disclosed in German application No. 103 38 139.2 of Aug. 19, 2003, which is incorporated herein by reference in its entirety and for all purposes.

### BACKGROUND OF THE INVENTION

The invention relates to a device for the manufacture of a shaft assembly for a hydrodynamic bearing comprising a shaft and a bearing disk for the rotary bearing of spindle motors by pressing the shaft into a fit bore in the bearing disk, the device comprising a first pressing tool accommodating the shaft and a second pressing tool accommodating the bearing disk.

In the devices known to date in respect of such shaft assemblies, the shaft is pressed into a fit bore disposed in the center of the bearing disk whose diameter is less than the shaft diameter by means of a first pressing tool accommodating the shaft and a second press tool accommodating the bearing disk.

Due to the strictest requirements placed on the right angularity between shaft and bearing disk for the completed shaft assembly, the parts that are to be joined have to be perfectly centered with respect to each other when the pressfit end begins to penetrate into the fit bore at the start of the pressfitting process.

Otherwise, through one-sided “touching”, local force peaks can occur which could lead to “seizing” or “scoring” of the parts that are to be joined and thus to non-tolerable deviations with respect to the required right angularity, evenness and cylindricality of the shaft assembly.

In the known devices used to pressfit a shaft into a bearing disk, the concentricity of the individual parts to be joined is inadequate due to the dimensional tolerances of the components as well as the holding apparatus of the receiving device. Moreover, the inserted disk may take on an undesirable inclination due to introduced particles, tiny pieces of grit, swarf or also due to microscopic deposits, so that the reject rate, taken as a whole, becomes too large for low-cost mass production.

The object of the invention is thus to provide a device for the manufacture of these kinds of shaft assemblies in which the disadvantages mentioned above have been remedied to a great extent so that particularly one-sided “touching” and the resulting “seizing” or “scoring” hardly ever take place, leading to a considerable reduction in the percentage of rejected parts.

### SUMMARY OF THE INVENTION

This object has been achieved for a device of the type described in the opening paragraphs in that the second pressing tool has a supporting member carried by the base member and accommodating the bearing disk that is to be pressed and that the supporting member is supported with respect to the base member in a radial direction to a central axis of the pressing tools by means of a media cushion formed from a medium, the supporting member floating on this media cushion and its movement in this radial direction being restricted.

The advantage of the solution presented in the invention can be seen in the fact that, by means of the media cushion, the supporting member can be moved essentially force-free in a radial direction with respect to the central axis and can thus center itself without any problems at the start of the process of pressfitting the bearing disk to the shaft to such an extent that “touching” with local force peaks, or even “seizing” can be almost fully prevented and the formation of grit, swarf or particles during the pressfit process can be extensively prevented.

In order to obtain a media cushion with defined characteristics, ducts are preferably provided in the base member to supply the media cushion with an inflowing medium.

In order to be able to again lead away the in-flowing medium, at least one duct is provided in the base member to carry off the medium flowing out of the media cushion.

In order to beneficially and precisely guide the supporting member despite the media cushion, the supporting member is preferably supported in a receiving portion of the base member in which the media cushion is formed.

The receiving portion enables the supporting member to be aligned and positioned in a sufficiently precise manner.

In order to prevent any disruption in the manufacture of the shaft assembly through soiling or swarf that is incurred or introduced, it is preferable if the supporting member is held in the receiving portion in such a way that it can be removed thus providing the possibility of easily exchanging the supporting member, either after a certain number of shaft assemblies have been manufactured or after each pressfitting process, and thus creating the possibility of cleaning the supporting member separately before its reuse in a pressfitting process.

The media cushion can be particularly easily disposed in the receiving portion if the supporting member is arranged in the receiving portion with a lower support surface facing the media cushion.

The receiving portion is preferably formed in the base member in such a way that it has a supporting surface abutting the media cushion so that the media cushion essentially is arranged between the supporting surface of the base member and the lower support surface of the supporting member, and the lower support surface of the supporting member is supported by the media cushion.

In principle, the medium could be a fluid. In view of the medium possibly soiling the shaft assembly, however, it is particularly favorable if the medium is a gas, particularly air.

In order to preliminarily center the bearing disk with respect to the shaft in a sufficiently satisfactory manner, it is preferably if the receiving portion has a boundary which restricts the movement of the supporting member in a radial direction with respect to the central axis so that, in particular, the chamfer located at the pressfit end of the shaft always finds its way into the fit bore in the bearing disk, thus preventing the end of the shaft located at the pressfit end from hitting the surface of the bearing disk.

A particularly favorable means of constructing the base member is provided if the receiving portion is formed from the face of a lower part, which forms supporting surface of the receiving portion, and an outer ring mounted on the lower part which forms the boundary.

The outer ring is preferably mounted in a positive-fit on the lower part and held onto the lower part in this way.

In order to align the bearing disk in a sufficiently precise manner with respect to the supporting body, it is preferable if an aligning element that centers the bearing disk is mounted on the supporting member.

The aligning element preferably engages an outer surface of the bearing disk in order to center it with respect to the supporting member.

In order to fix the aligning element for its part vis-à-vis the supporting member, provision is preferably made for the aligning element to engage the supporting member in a positive-fit, for example, at a peripheral surface.

So far, no precise details have been given concerning the accommodation and securing of the shaft in the first pressing tool to pressfit the pressfit end of the shaft. A particularly favorable solution provides that the first pressing tool has a receiving bore for the shaft which allows the shaft to be fixed in the first pressing tool in a sufficiently precise manner.

It is particularly favorable if the shaft can be secured in the receiving bore by means of a holding force generated by a difference in pressure to prevent the shaft from falling out before it is pressfitted into the bearing disk.

Further characteristics and advantages of the invention form the subject matter of the description below as well as the illustration in drawings of an embodiment.

### BRIEF DESCRIPTION OF THE DRAWINGS

FIG. 1 a schematic view of a shaft assembly to be manufactured according to the invention, comprising a shaft and a bearing disk;

FIG. 2 a vertical section through a device for the manufacture of the shaft assembly illustrated in FIG. 1 by pressfitting the shaft into the bearing disk;

FIG. 3 an enlarged view of the region A in FIG. 2 and

FIG. 4 a view of the device similar to FIG. 2 but rotated by about 90° with respect to it at the end of the pressfitting process.

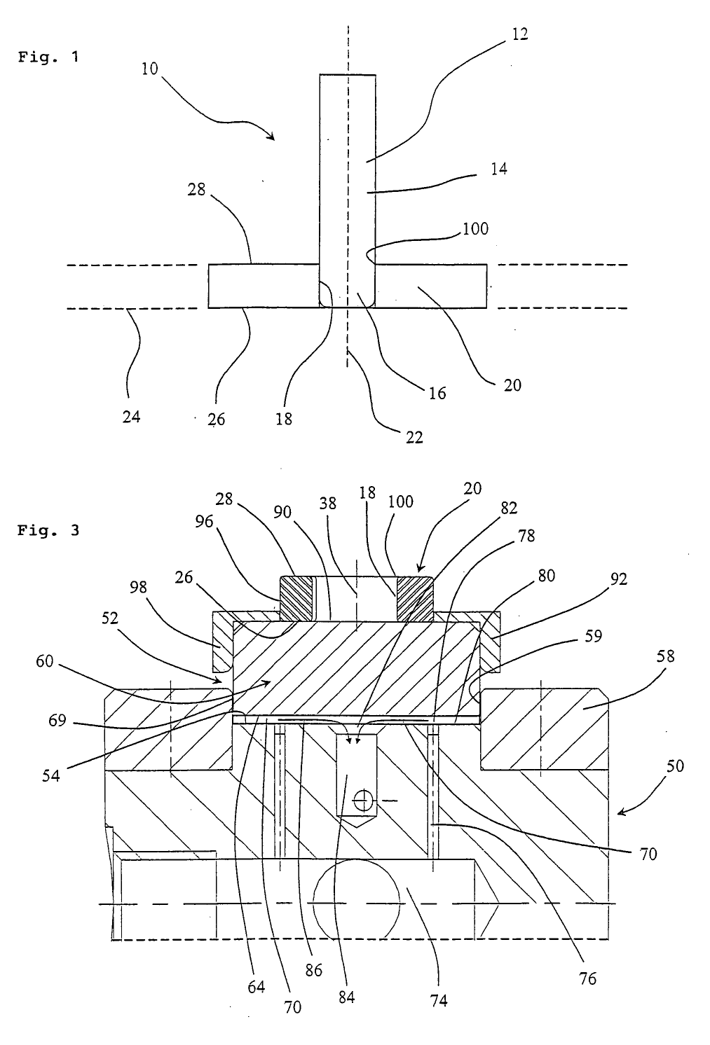

### DETAILED DESCRIPTION OF THE INVENTION

A shaft assembly 10 for a hydrodynamic bearing of an electric spindle motor to be manufactured according to the invention comprises a shaft 12 which is ground on its peripheral face 14 and which is pressed at one pressfit end 16 into the fit bore 18 of a bearing disk 20, the fit bore 18, for example, being formed as a through hole.

An essential feature of such a shaft assembly 10 is that the axis 22 of the shaft assembly 10 is exactly perpendicular to a lower surface 26 of the bearing disk 20 extending in a plane 24 and also exactly perpendicular to an upper surface 28 of the bearing disk 20 which also runs parallel to the plane 24 since the lower surface 26 and the upper surface 28 of the bearing disk 20 are responsible for the axial supporting of the shaft assembly 10 in the hydrodynamic bearing.

In the known devices used to press the shaft 12 at the pressfit end 16 into the fit bore 18 of the bearing disk 20, a more or less significant concentricity error occurs between the parts that are to be joined due to component and insertion tolerances which can lead to touching, and as a result of local force peaks, even to “seizing”, which means that some reject parts are almost always produced. This results in costly cleaning processes involving partial dismantling of the device and always means at least a temporary shutdown of production.

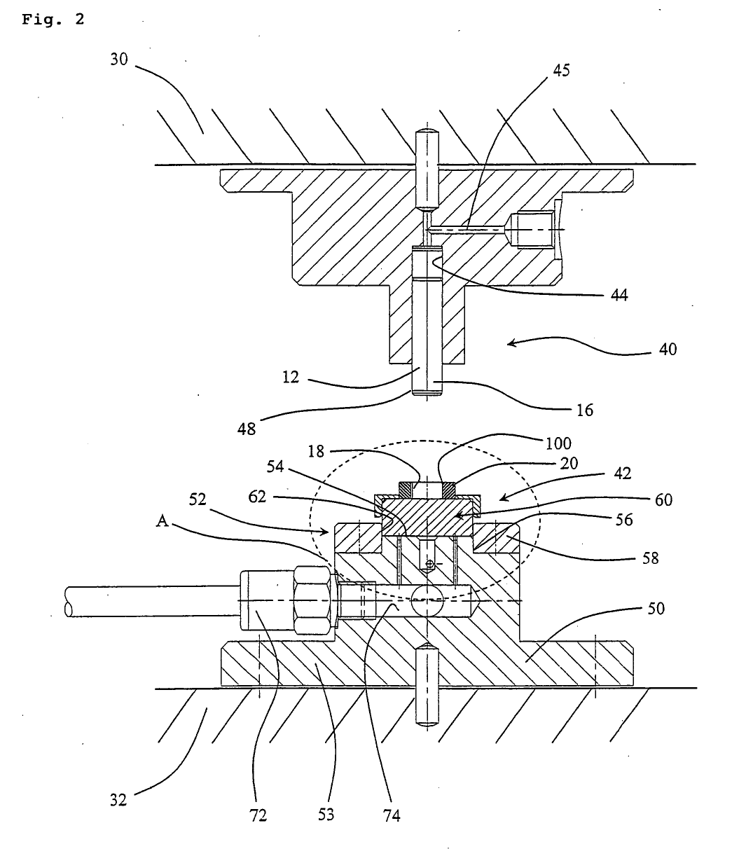

Such problems are largely avoided by a device according to the invention as illustrated in FIG. 2.

As in a conventional pressing device, this device comprises a plunger 30 and a pressing device counter support 32 which can, for example, be pneumatically moved towards each other.

A first pressing tool 40 and a second pressing tool 42 are respectively disposed on the plunger 30 and the counter support 32, coaxial to a central axis 38.

The first pressing tool 40 to accommodate the shaft 12 is provided coaxial to the central axis 38 and has, for example, a bore 44 coaxial to the central axis 38 to accommodate the shaft 12, the shaft 12 projecting at the pressfit end 16 from the first pressing tool 40 in the direction of the second pressing tool 42.

To secure the shaft 12 in the bore 44 of the first pressing tool 40 for the pressfitting process, the bore 44 is provided at its end with a duct 45 led through the first pressing tool 40 through which a partial vacuum can be applied. This vacuum acts on the end face of the shaft 12 located in the bore 44 while the other end face of the shaft 12 is subjected to the surrounding pressure. The resulting pressure difference generates a holding force, acting in the opposite direction to gravity, that secures the shaft 12 within the bore 44.

To center the bearing disk 20 with respect to the shaft 12 at the start of pressfitting, the shaft 12 has a chamfer 48 in the region of a transition from the pressfit end 16 to the end face 46 facing the second pressing tool 42.

The second pressing tool 42, which is disposed on the counter support 32, comprises a base member 50 having a receiving portion 52 in which a supporting member 60 is exchangeably inserted.

To form the receiving portion 52, the base member 50 is preferably provided with a lower part 53 which forms a supporting surface 54 at the side facing the first pressing tool 40. This supporting surface 54 is surrounded by a recoiling step 56 on which a ring 58 is disposed in a positive fit whose height is greater than the depth of the step 56, so that the ring 58 encloses the edge of the supporting surface 54 and projects vis-à-vis the supporting surface 54 in the direction of the first pressing tool 40. The projecting part of the inner cylindrical sleeve surface 62 of the ring 58 forms a concentric boundary for the supporting surface 54 and thus completes the open-ended receiving portion 52 for the supporting member 60.

The disk-shaped supporting member 60 inserted into this receiving portion 52 has ground coplanar end faces of which one, acting as a lower support surface 64, is located opposite the supporting surface 54 and interacts with this supporting surface 54 in a function-determining way, as well as an outer cylindrical sleeve surface 69 whose diameter is smaller than the inner cylindrical sleeve surface 62 of the ring 58. As a result of the difference in diameter between the two cylindrical sleeve surfaces 69, 62 and the at least partial overlap in an axial direction, the supporting member 60 located in the receiving portion 52 can be moved within limits transversely to the central axis 38 within the tolerance created by the difference in diameter.

An air cushion, indicated in its entirety by 70, can be formed in the receiving portion 52 between the supporting surface 54 and the lower support surface 64, for whose purpose, as illustrated in FIGS. 2 and 3, a distribution channel 74 runs from an air supply connection 72 of the base member 50 disposed in the lower part 53, into the lower part 53, supply ducts 76 branching off from the distribution channel 74, all of which, as illustrated particularly in FIG. 3, having an orifice 78 located in the supporting surface 54, the orifices 78 preferably being located in an off-center region 80 of the supporting surface 54.

Moreover, another orifice 82 for an outflow duct is located approximately at the center of the supporting surface 54 through which air from the air cushion 70 can flow out and, for example, be discharged into the surroundings.

This means that the air cushion 70 is always interfused with an airflow 86 which extends from the orifices 78 of the supply ducts 76 through the air cushion 70 to the orifice 82 of the outflow duct 84.

Since the air cushion 70 thus formed, on which the supporting member 60 floats with its lower support surface 64, is extremely thin and essentially has a very even thickness, the supporting face 90 of the supporting member 60 lying coplanar to the lower support surface 64 on which the bearing disk 20 is placed, lies in a parallel plane to the lower support surface 64 in order to ensure that the surfaces 26, 28 of the bearing disk 20, parallel to each other, are aligned in a sufficiently precise manner in order to maintain the required right angularity between the shaft 12 and the bearing disk 20, the bearing disk 20 lying, in the simplest version, with its lower surface 26 on the supporting face 90 of the supporting member 60.

To preliminarily center the bearing disk 20 placed on the supporting member 60 with respect to the central axis 38, an aligning element is moreover provided which is indicated in its entirety by 92. The aligning element 92 is placed over the supporting member 60 and secured to the supporting member 60 in a positive-fit by this means. The aligning element 92 lies on the supporting face 90 of the supporting member 60, is centered via the inner cylindrical sleeve surface of a collar 98 on the outer cylindrical sleeve surface 69 of the supporting part 60 and is provided with a concentric recess 94 to accommodate the inserted bearing disk 20. The bearing disk 20 lies with its outer sleeve surface 96 on the corresponding wall of the recess 94 so that the bearing disk 20 is preliminarily centered on the supporting face 90 in a sufficiently precise manner.

To pressfit the shaft 12 into the bearing disk 20, the first pressing tool 40 and the second pressing tool 42 are moved towards each other. Here, the bearing disk 20 is in such a pre-centered position with respect to the central axis 38 that the chamfer 48 can interact with an edge 100 of the fit bore 18 facing the first pressing tool 40. This means that when the chamfer 48 enters into the fit bore 18, due to one-sided contact of the edge 100, the bearing disk 20 together with the supporting member 60 undergoes a parallel displacement with respect to the axis 38 and in this way is placed in an exact, final position with respect to the shaft 12, since, due to the air cushion 70, the supporting member 60 can move in a radial direction to the central axis 38, essentially resistance-free, within the tolerance allowed by the receiving portion 52 so that the unit consisting of the supporting member 60 and the bearing disk 20 can be moved parallel to the axis 38, requiring almost no force, for the final centering of the bearing disk 20 with respect to the shaft 12.

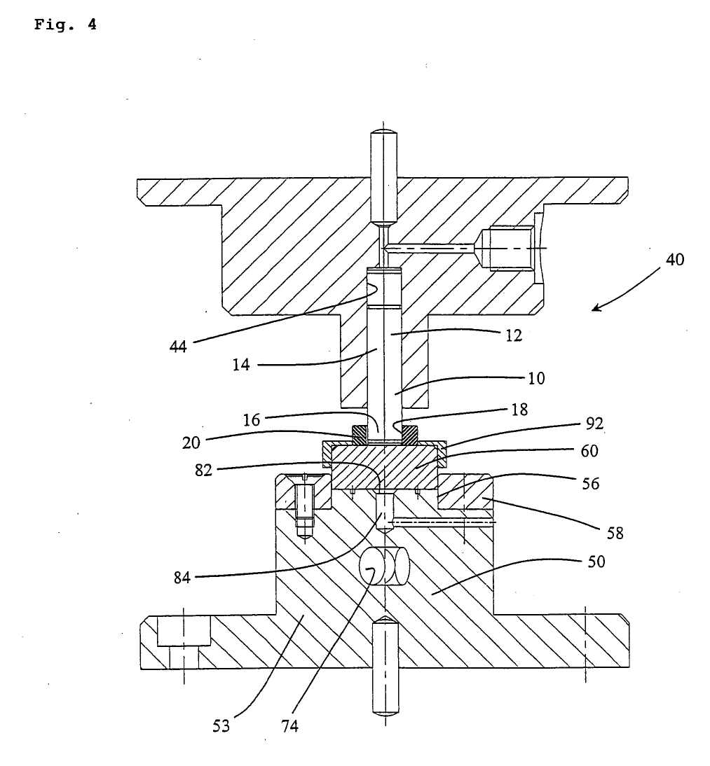

Once the bearing disk 20 has been finally centered, the shaft 12 can be pressed into the fit bore 18 of the bearing disk 20 at its pressfit end 16 without burrs, swarf or particles being formed, up to the point where, as illustrated in FIG. 4, the end face 46 of the shaft 12 is essentially flush with the surface 26 of the bearing disk 20.

The compression of the air cushion occurring when the pressfit end 16 of the shaft 12 is fully pressed into the bearing disk 20 is insignificant since the air cushion 70 is only needed for the initial centering of the bearing disk 20 with respect to the shaft 12 and does not have any further function once the pressfit end 16 has been fully pressed into the bearing disk 20.

Once the shaft assembly 10 has been completed, it can be removed from the device presented in the invention and the supporting member 60 can also preferably be removed when the shaft assembly 10 is removed from the receiving portion 52 and, where applicable, undergo a separate cleaning process, and when a new bearing disk 20 is inserted, a new, clean supporting member 60 can be used.

Identification Reference List

10 Shaft assembly
12 Shaft
14 Peripheral face
16 Pressfit end
18 Fit bore
20 Bearing disk
22 Axis
24 Plane
26 Surface
28 Surface
30 Plunger
32 Counter support
38 Central axis
40 Pressing tool
42 Pressing tool
44 Bore
45 Duct
46 End face
48 Chamfer
50 Base member
52 Receiving portion
53 Lower part
54 Supporting surface
56 Step
58 Ring
59 (Inner) cylindrical sleeve surface
60 Supporting member
64 Lower support surface
69 (Outer) cylindrical sleeve surface
70 Air cushion
72 Air supply connection
74 Distribution channel
76 Supply duct
78 Orifice
80 Off-center region
82 Orifice
84 Outflow duct
86 Airflow
90 Supporting face
92 Aligning element
94 (Concentric) recess
96 Outer surface
98 Collar
100 Edge

1. A device for the manufacture of a shaft assembly for a hydrodynamic bearing by pressing a shaft into a fit bore of a bearing disk, the device comprising a first pressing tool accommodating the shaft and a second pressing tool accommodating the bearing disk, the second pressing tool having a supporting member carried by the base member and accommodating the bearing disk for being pressed, and the supporting member being supported with respect to the base member in a radial direction to a central axis of the pressing tools by means of a media cushion formed from a medium, the supporting member floating on this media cushion and its movement in this radial direction being restricted.

2. A device according to claim 1, wherein ducts for supplying the media cushion with an inflowing medium are provided in the base member.

3. A device according to claim 1, wherein at least one duct is provided in the base member to carry off the medium flowing out of the media cushion.

4. A device according to claim 1, wherein the supporting member is supported in a receiving portion of the base member in which the media cushion is formed.

5. A device according to claim 1, wherein the supporting member is held in the receiving portion in such a way that it can be removed.

6. A device according to claim 4, wherein the supporting member is arranged in the receiving portion with a lower support surface facing the media cushion.

7. A device according to claim 6, wherein the receiving portion has a supporting surface abutting the media cushion.

8. A device according to claim 1, wherein the medium is a gas.

9. A device according to claim 4, wherein the receiving portion has a boundary which restricts movement of the supporting member in a radial direction with respect to the central axis.

10. A device according to claim 4, wherein the receiving portion is formed by the face of a lower part, which forms the supporting surface of the receiving portion, and an outer ring mounted on the lower part which forms the boundary.

11. A device according to claim 10, wherein the outer ring is mounted in a positive-fit on the lower part.

12. A device according to claim 1, wherein an aligning element centering the bearing disk is mounted on the supporting member.

13. A device according to claim 12, wherein the aligning element engages an outer surface of the bearing disk.

14. A device according to claim 12, wherein the aligning element engages the supporting member in a positive-fit.

15. A device according to claim 1, wherein the first pressing tool has a receiving bore for the shaft.

16. A device according to claim 15, wherein the shaft is held in the receiving bore by means of a holding force generated by a difference in pressure.
